(19) United States
(12) Patent Application Publication
(10) Pub. No.: US 2009/0221199 A1
(43) Pub. Date: Sep. 3, 2009

(54) JetRay Watercraft

(75) Inventor: D.Loran Curet Troche, Rochester, NY (US)

Correspondence Address: GERALD J. CECHONY, 7701 MCCALLUM STREET, PHILADELPHIA, PA, 19118, US

(73) Assignee: D. Loran Curet Troche, Rochester, NY (US)

(21) Appl. No.: 11/754,251

(22) Filed: Feb. 28, 2008

(51) Int. Cl. B63B 35/79; B60L 11/12

(52) U.S. Cl. 441/74; 290/50

(57) ABSTRACT

The present invention provides an improved board for transporting a human over water or snow with shock absorption means for reducing impact to body parts. Impact reduction leads to tolerance of faster speeds, better control of the watercraft, improved vision for guidance, and less harmful impact on the human body; in particular the knee joints and lower back.

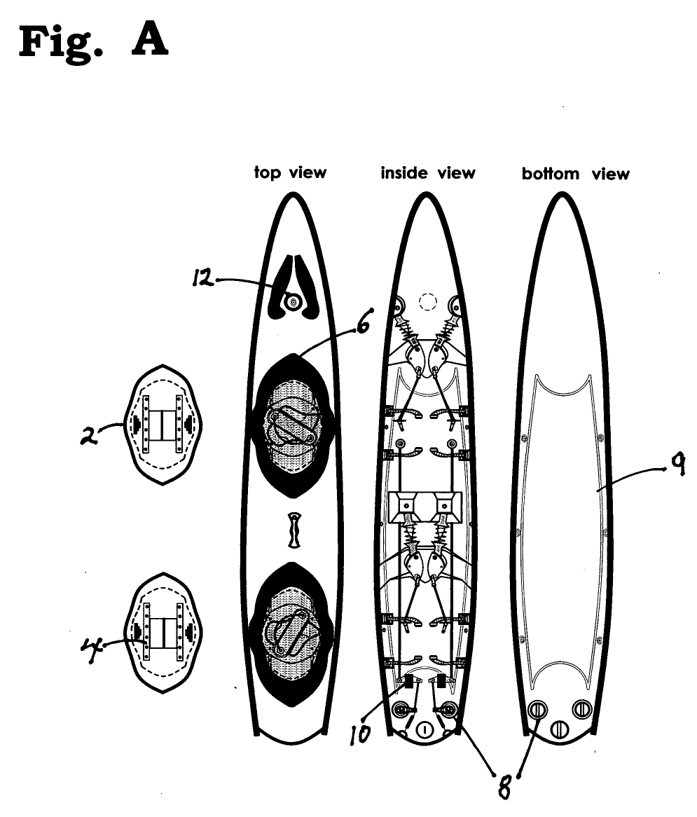

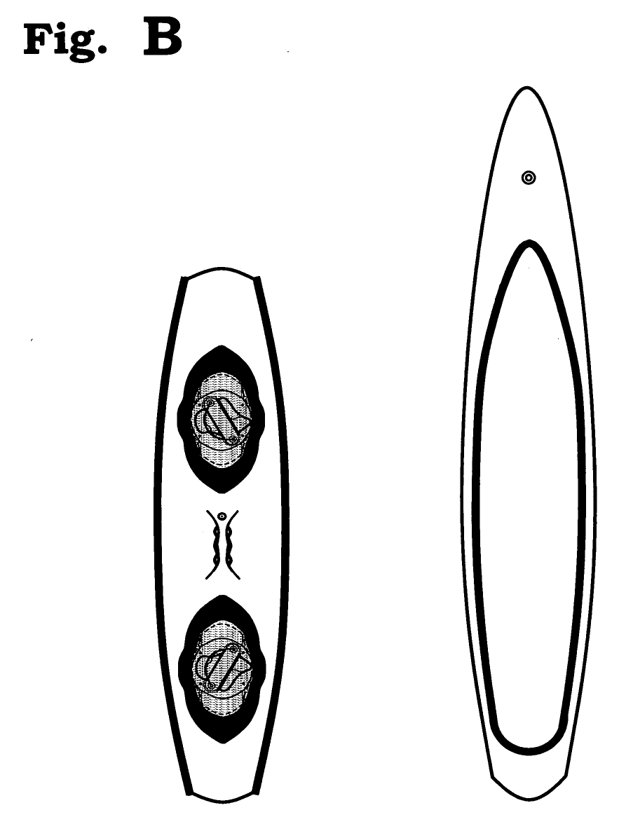

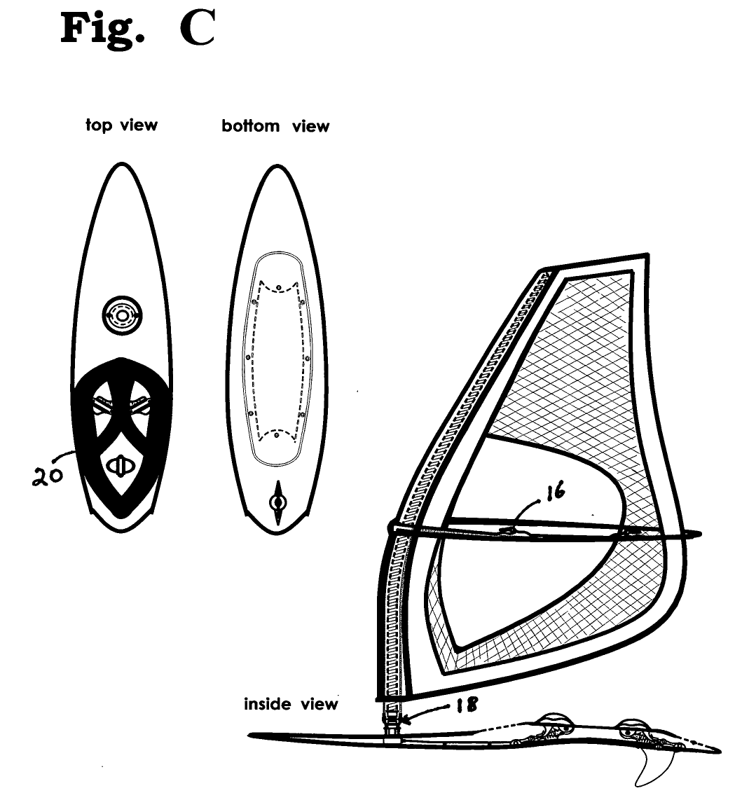

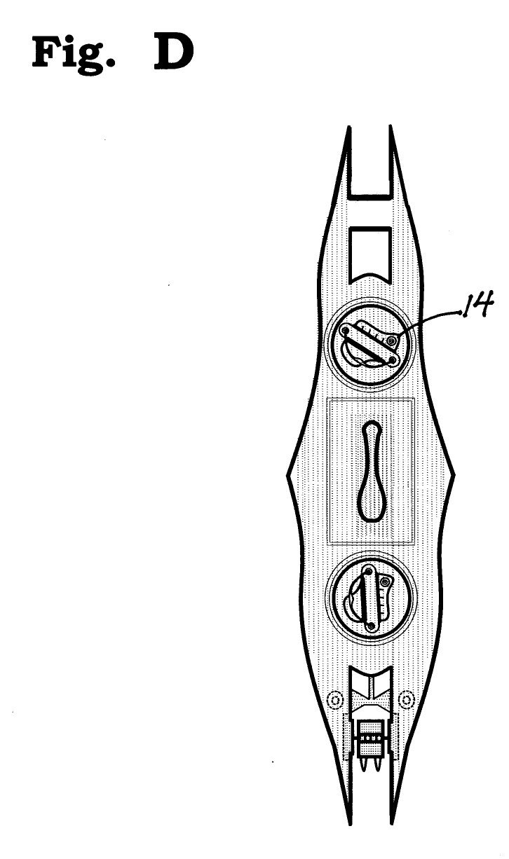

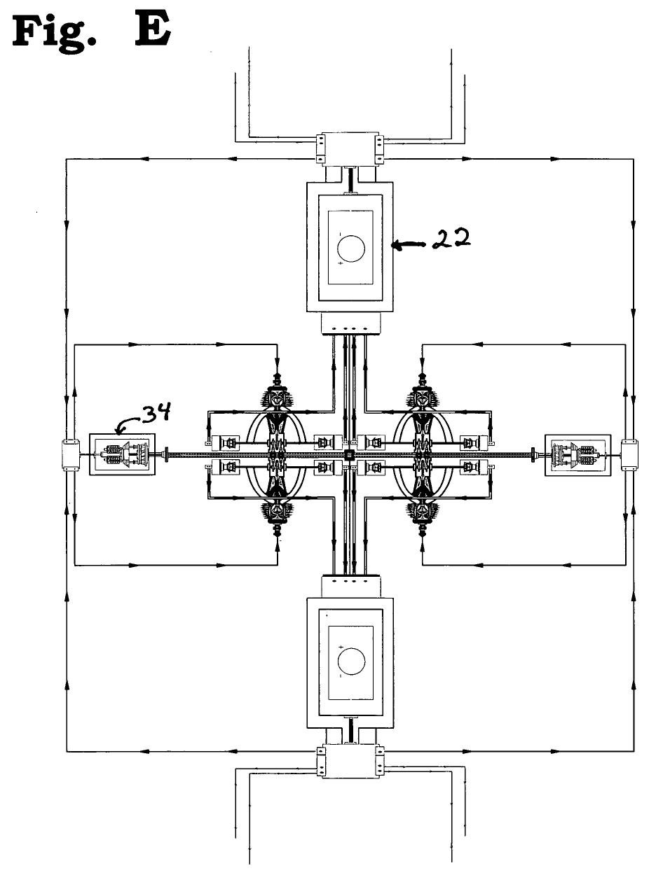

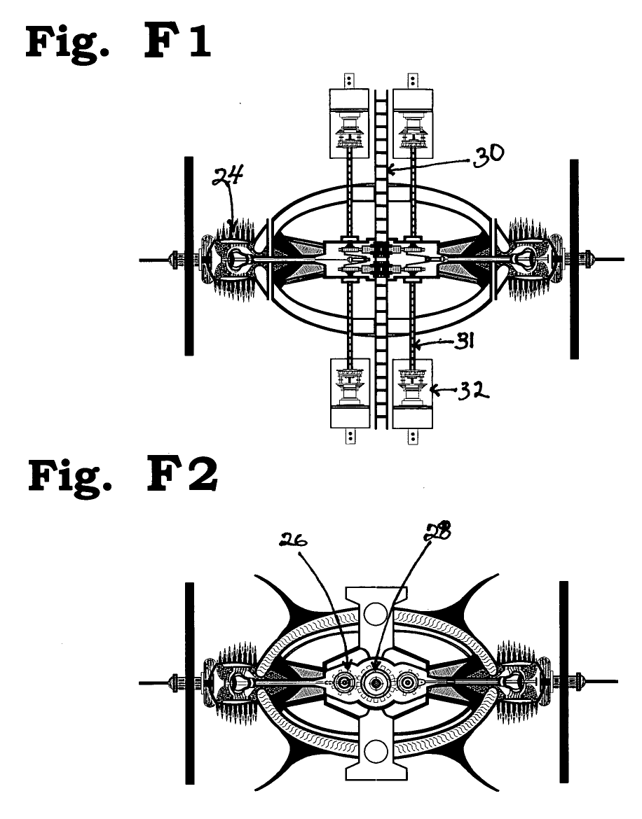

### BACKGROUND OF THE INVENTION

1. Field of the Invention

This invention pertains to a new and useful development for improvement in water surfing sports, including towed and non-towed surface water sports. The invention provides a human watercraft transporter and a shock absorber design applicable to water surfing sports as well as snowboards.

2. Related Art

Surface water sports, including but not limited to big wave surfing, wind surfing, kite surfing and tow surfing, expose the rider to significant bodily impact. The water turbulence under the board translates into impact on the body's joints in addition to creating surfer instability on the watercraft.

### BRIEF SUMMARY OF THE INVENTION

The present invention involves the addition of shock absorbers, such as coil springs and air valves, as well as a new board design for alleviation of this impact. Impact reduction will likely lead to tolerance of faster speeds, better control of the watercraft, improved vision for guidance, and less harmful impact on the human body—in particular the knee joints and lower back. The human watercraft transporter is a reciprocal energy generating transporter with a reciprocal energy generating system applicable to any motor watercraft.

Other advantages of the present invention will be apparent to those skilled in the art from the ensuing description and the appended drawings, wherein:

### BRIEF DESCRIPTION OF THE DRAWINGS

FIG. A depicts a surfboard design applicable to wake boarding, kite boarding as well as snowboarding.

FIG. B depicts a single-deck surfboard and a double deck surfboard

FIG. C depicts a triple-deck surfboard and windsurfing design

FIG. D depicts a human watercraft transporter also applicable to motor surfboards

FIG. E shows a watercraft transporter reciprocal energy generating system

FIG. F depicts a reciprocal energy generating system

FIG. F1 is an enlarged view of pistons, motors, and gears

FIG. F2 is a side view of the reciprocal energy generating system

### DETAILED DESCRIPTION OF THE INVENTION

Shock-Absorber System

The board will be made of the usual light-weight material such as carbon fiber or foam. Within the board there will be shock absorbers such as coil springs. One end of the shock absorbers will be attached to the inside of the board while the other end will be attached to the underside of the cockpit (FIG. A). The cockpit (2) will contain the axle (4) for the entire system. The rider will stand on the cockpit with or without foot straps or boots. The cockpit will be flexible to help minimize impact on the body while the board remains sturdy on the water. There will be a waterproof flexible material (6) between the board and the cockpit which will contribute to the separation in movement between the cockpit and the board when confronted with impact from the water; or land in the case of snowboarding (FIG. B). The underside of the board will have parallel fins for directing the board on the water, but will also have the option of an additional fin for the surfer to steer (8). A special network of cable connections (8), gear boxes (10) and springs will allow the fin to be controlled by means of the surfer leaning in one direction or the other (FIG. A). This fin will allow for improved control in turning the surfboard left or right. An opening at the bottom of the board for the purposes of working the inner parts (9). An adjustable buoyancy valve (12) will serve to adjust the shocks by compressing or decompressing air for the “springs” in the shock absorbers similar to adjusting a bicycle with “air” coil shock absorbers. The buoyancy valve also creates resistance for the rider base on his or her own weight, making the board unique for every individual. The buoyancy valve allows the board to be small in size but very resistant by weight ratio.

There are several different deck designs. There is the single deck board (FIG. B), the double deck board (FIG. B), and the triple deck board (FIG. C). There is also a circular movement design for the cockpit which will serve more so for motor surfboards or other such motor run devices (FIG. D). The circular cockpit (15) also have a foot accelerator which is controlled with one's toes (14). Some of these devices can also be applied to windsurfing as illustrated in FIG. C. With windsurfing there will also be a controllable fin but in this case the fin will be controlled by way of handles (16) on the handle bar. In addition there will be a gyro (18) for rotation of the central boom. The triple cockpit design (20) will be most useful in windsurfing allowing for foot repositioning when rotating the sail. Available to all the motor run watercrafts will be my watercraft transporter (FIG. E).

Watercraft Transporter:

This system is a reciprocal energy generating system (FIG. E) with the initial power produced by rechargeable batteries (22). The batteries then move a set of pistons (FIG. F1, 24) which then move linked side gears (F2, 26). The movement of these side gears move a central gear (F2, 28) just as the gears in a clock would function. The side gears are attached to side shafts (F1, 31) connected to motors (F1, 32) and the central gear is attached to a central shaft (F1, 30) connected to generators (FIG. E, 34). The rotation of side shafts attached to motors help move the central gear and shafts providing energy for the system. The energy from the motors recharges the batteries as well as providing energy for the watercraft motion. Energy from the generators is sent back to the pistons to continue the cycle of energy production. Microchips within the system will help direct the energy circuits.

Although the above description has been directed to preferred embodiments of the invention, it will be understood and appreciated by those skilled in the art that other variations and modifications may be made without departing from the spirit and scope of the invention, and therefore the invention includes the full range of equivalents of the features and aspects set forth in the claims

What is claimed is:

1. A shock absorbing system for use in surface water sport boards including surfboards, kite boards, and wind surfers.

2. A mechanical arrangement within a water sport board, set to control the movement of one or many fins.

3. A surfboard design with air and spring shock absorbers and an adjustable buoyancy valve.

4. A reciprocal energy generating system arrangement applicable to any level of size including macro, micro, nano levels.

5. A surfboard design as claimed in claim 3, wherein said design includes a single deck platform

6. A surfboard design as claimed in claim 3, wherein said design includes a double deck platform

7. A surfboard design as claimed in claim 3, wherein said design includes a triple deck platform

8. A surfboard design as claimed in claim 3, wherein said design includes a circular cockpit for motor watercrafts.

9. A surfboard design as claimed in claim 3, wherein said design includes a removable work door on the underside of the board.

10. A surfboard design as claimed in claim 3, wherein said design includes handles for control of mechanical fins and a gyro for prevention of cable entanglement on windsurfing boards.
